(19) United States
(12) Patent Application Publication
(10) Pub. No.: US 2025/0125532 A1
(43) Pub. Date: Apr. 17, 2025

(54) RADIO WAVE REFLECTOR AND CONSTRUCTION MATERIAL

(71) Applicant: SEKISUI CHEMICAL CO., LTD., Osaka (JP)

(72) Inventor: Hiroyuki NOMOTO, Osaka (JP)

(73) Assignee: SEKISUI CHEMICAL CO., LTD., Osaka (JP)

(21) Appl. No.: 18/834,111

(22) PCT Filed: Dec. 23, 2022
(86) PCT No.: PCT/JP2022/047520

§ 371 Date: Jul. 29, 2024

(30) Foreign Application Priority Data
Feb. 1, 2022 (JP) 2022-014485

(51) Int. Cl. H01Q 15/14

(52) U.S. Cl. CPC H01Q 15/14

(57) ABSTRACT

Provided are a radio wave reflector and building material that have flexibility and reflect radio waves while the intensity thereof is maintained. A radio wave reflector 11 for reflecting radio waves, wherein when the radio wave reflector 11 is in a flat state and is caused to reflect a radio wave at an incident angle of an incident wave of 15 degrees or more and 75 degrees or less, the intensity of a reflective wave as specular reflection of the incident wave is −30 dB or more relative to the intensity of the incident wave at least at one frequency; the change rate of the surface resistivity R2 of the radio wave reflector 11 curved along a curved surface with a curvature radius of 200 mm with respect to surface resistivity R1 of the radio wave reflector 11 in a flat state is −10% or more and 10% or less; and the radio wave reflector 11 has a flexural modulus of 0.05 GPa or more and 4 GPa or less.

### TECHNICAL FIELD

The present invention relates to a radio wave reflector and building material for reflecting radio waves.

### BACKGROUND ART

Cellular phones and wireless communications use radio waves in the frequency band of about 2 GHz or more and 300 GHz or less. Since such radio waves with a short wavelength have high straight-advancing properties, and circumvention is difficult even in the presence of obstacles, reflectors are used to deliver radio waves over a wide area of space. For example, Patent Literature (PTL) 1 proposes a communication system in which a monopole antenna and a metal reflector for reflecting radio waves are arranged in an underfloor space within a building. In PTL 1, radio waves emitted from the monopole antenna are diffused in the underfloor space while the radio waves are prevented from leaking from the underfloor space to the outside of the living room (the building) or from being absorbed on the floor of the building.

### CITATION LIST

### Patent Literature

PTL 1: JP2010-258514A

### SUMMARY OF INVENTION

### Technical Problem

Metal reflectors for reflecting radio waves are typically composed of a metal plate, such as aluminum or copper. Although metal reflectors reflect radio waves having a short wavelength with high intensity in the specular reflection direction, it is known that they are unlikely to diffusely reflect radio waves, making it difficult to deliver radio waves over a wide area of space. In order to deliver radio waves to a desired area of space, a metal reflector is attached at an appropriate angle to an installation surface, such as a wall or a pillar in a living room, to reflect radio waves in a desired direction.

Metal reflectors are typically not flexible and have high rigidity, Thus, if an installation surface, such as a wall or a pillar, is curved, metal reflectors cannot be attached. If an installation surface is uneven, fine adjustments such as slightly tilting the reflective surface of a metal reflector are not possible, and the angle of the reflective surface of the metal reflector significantly deviates from a desired angle. Since metal reflectors are not flexible as described above, it is difficult to create an environment for radio wave reflection in a living room.

An object of the present invention is to provide a radio wave reflector and building material that have flexibility and reflect radio waves while the intensity of radio waves is maintained.

### Solution to Problem

To achieve the above object, the present invention encompasses the subject matter described in the following Items.
Item 1. A radio wave reflector for reflecting radio waves,
   wherein
when the radio wave reflector is in a flat state and is caused to reflect a radio wave at an incident angle of an incident wave of 15 degrees or more and 75 degrees or less, the intensity of a reflective wave as specular reflection of the incident wave is −30 dB or more relative to the intensity of the incident wave at a frequency,
the change rate of the surface resistivity of the radio wave reflector curved along a curved surface with a curvature radius of 200 mm with respect to the surface resistivity of the radio wave reflector in a flat state is −10% or more and 10% or less, and
the radio wave reflector has a flexural modulus of 0.05 GPa or more and 4 GPa or less.
Item 2. The radio wave reflector according to Item 1, wherein the incident wave has any frequency of 2 GHz or more and 300 GHz or less.
Item 3. The radio wave reflector according to Item 1 or 2, which has a Young's modulus of 0.01 GPa or more and 80 GPa or less.
Item 4. The radio wave reflector according to any one of Items 1 to 3, which has a thickness of 0.01 mm or more and 0.5 mm or less.
Item 5. The radio wave reflector according to any one of Items 1 to 4, which comprises at least a conductive thin film layer comprising an electric conductor for reflecting radio waves, and a substrate layer comprising a substrate and laminated to the conductive thin film layer.
Item 6. The radio wave reflector according to any one of Items 1 to 5,
   wherein
the radio wave reflector comprises a conductive thin film layer comprising an electric conductor for reflecting radio waves, a substrate layer comprising a substrate and laminated to the conductive thin film layer, a protective layer comprising a protective material for protecting the conductive thin film layer, and an adhesive layer comprising an adhesive for bonding the conductive thin film layer and the layer comprising the protective material, and
the substrate layer, the conductive thin film layer, the adhesive layer, and the protective layer are laminated in this order.

Item 7. The radio wave reflector according to any one of Items 1 to 6, wherein the surface resistivity of the radio wave reflector in a flat state is 0.003 Ω/□ or more and 10 Ω/□ or less.
Item 8. The radio wave reflector according to Item 6, wherein the protective layer is subjected to anti-glare treatment or anti-reflection treatment.
Item 9. A building material comprising the radio wave reflector of any one of Items 1 to 8.

### Advantageous Effects of Invention

The present invention provides a radio wave reflector that has flexibility and reflects radio waves while the intensity of radio waves is maintained.

### BRIEF DESCRIPTION OF DRAWINGS

FIG. 1 is a diagram for explaining the angle range of reflective wave reflected from a radio wave reflector according to one embodiment of the present invention.

FIG. 2 is a cross-sectional view along the B-B line in FIG. 3(B) and shows the overall schematic configuration of a radio wave reflector according to one embodiment of the present invention.

FIG. 3 shows the overall schematic configuration of the radio wave reflector shown in FIG. 2. FIG. 3(A) is a plan view, and FIG. 3(B) is an enlarged view of the portion A in FIG. 3(A).

FIGS. 4(A) to 4(E) are plan views of an electric conductor showing other examples of arrangement patterns of an electric conductor.

FIG. 5 is a plan view of an electric conductor showing another example of an arrangement pattern of an electric conductor.

FIG. 6 is a plan view of a radio wave reflector showing another example of an arrangement pattern of an electric conductor.

FIG. 7 is a cross-sectional view showing the schematic configuration of a radio wave reflector according to another embodiment.

FIG. 8 is a cross-sectional view showing the schematic configuration of a radio wave reflector according to another embodiment.

FIG. 9(A) is an explanatory drawing showing an application example of a building material to a building, and FIG. 9(B) is a plan view showing an application example of the building material to the inside of a room.

FIG. 10 is an explanatory drawing illustrating a method for evaluating reflection direction-correcting properties.

FIG. 11 is an explanatory drawing illustrating a method for evaluating unevenness followability. (A) is a side view and (B) is a front view.

### DESCRIPTION OF EMBODIMENTS

### Overall Configuration

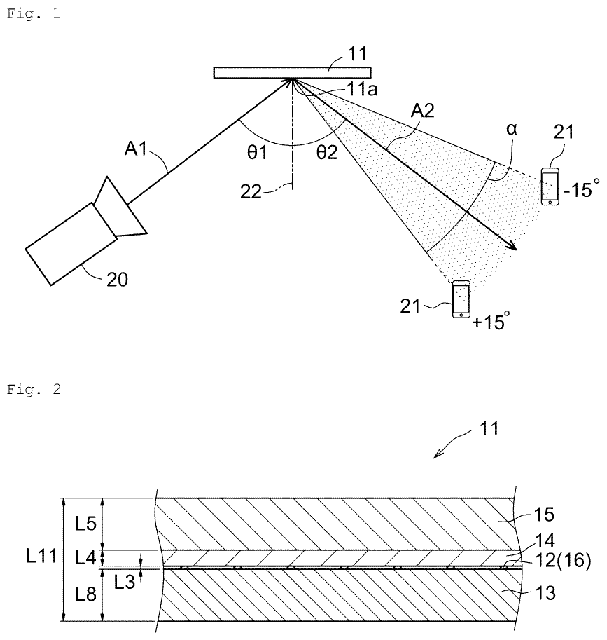

Embodiments of the present invention are described with reference to the drawings. As shown in FIG. 1, a radio wave reflector 11 according to this embodiment reflects radio waves output from a radio wave source 20. The reflected reflective waves are received by a receiver 21. The radio wave source 20 is, for example, a communication apparatus with a transmitting antenna capable of transmitting radio waves. The receiver 21 is a device capable of receiving radio waves. The receiver 21 according to this embodiment is a communication device with a receiving antenna. Examples of the communication device include smartphones, cellular phones, tablet computing devices, laptop PCs, portable game consoles, repeaters, radios, and televisions.

The radio wave reflector 11 comprises an electric conductor 12 for reflecting radio waves. The radio wave reflector 11 is caused to reflect a radio wave at least at a predetermined incident angle of an incident wave in the range of 15 degrees or more and 75 degrees or less, preferably at 45 degrees, more preferably at all of the angles in the range of 15 degrees or more and 75 degrees or less, at a frequency of the incident wave of 2 GHz or more and less than 6 GHz, 6 GHz or more and less than 20 GHz, 20 GHz or more and less than 60 GHz, 60 GHz or more and less than 100 GHz, 100 GHz or more and less than 150 GHz, or 150 GHz or more and 300 GHz or less, with the radio wave reflector 11 being in a flat state. In this case, the intensity of the reflective wave as specular reflection of the incident wave from the radio wave reflector 11 (also referred to below as the “specular reflection intensity”) is −30 dB or more and 0 dB or less relative to the incident wave at least at one frequency. Preferably, at a frequency of 28.5 GHz, the specular reflection intensity is −30 dB or more and 0 dB or less relative to the incident wave, More preferably, in the entire frequency band of 20 GHz or more and 60 GHz or less, the specular reflection intensity is −30 dB or more and 0 dB or less relative to the incident wave. Even more preferably, in the entire frequency band of 2 GHz or more and 300 GHz or less, the specular reflection intensity is −30 dB or more and 0 dB or less relative to the incident wave. The phrase “specular reflection intensity” refers to the reflection intensity that is the intensity with which a radio wave is reflected and that is the intensity of the reflective wave as specular reflection of the incident wave. The term “flat” means a state in which there is no unevenness and no curves, or a state in which the curvature radius at any point on the surface is 1000 mm or more even if there is unevenness.

The specular reflection intensity is preferably −25 dB or more and 0 dB or less, more preferably −22 dB or more and 0 dB or less, even more preferably −20 dB or more and 0 dB or less, and still even more preferably −15 dB or more and 0 dB or less, relative to the incident wave. When the specular reflection intensity is −30 dB or more relative to the incident wave, the radio wave reflector 11 can reflect radio waves while the reflection intensity is kept high, and the receiver 21 can receive radio waves with an intensity that is practical for use. In this embodiment, the specular reflection intensity and the reflection intensity are values obtained when the distance between the reflection point 11a of the radio wave reflector 11 and the radio wave source 20, and the distance between the reflection point 11a of the radio wave reflector 11 and the receiver 21, are each set to 1 m.

Referring to FIG. 1, specular reflection means that the incident angle θ1 of an incident wave and the reflection angle θ2 of a reflective wave are equal to each other when a radio wave emitted from the radio wave source 20 (a transmitting antenna) is reflected from the radio wave reflector 11. The reflection direction of the reflective wave as specular reflection of a radio wave is also called the “specular reflection direction.” The incident angle θ1 is an angle formed by an incident wave traveling in the incident direction in which a radio wave is incident on the radio wave reflector 11 (indicated by an arrow A1 in FIG. 1) and a normal line 22 of the reflective surface of the radio wave reflector 11, while the reflection angle θ2 is an angle formed by a reflective wave traveling in the reflection direction (indicated by an arrow A2 in FIG. 1) and the normal line 22 of the reflective surface. The normal line 22 is a straight line perpendicular to the tangent line (or the tangent plane) at the reflection point 11a. The intensity of the reflective wave may be hereinafter referred to as “reflection intensity.”

The surface resistivity of the radio wave reflector 11 in a flat state is 0.003 Ω/□ or more and 10 Ω/□ or less. As described in detail later, the surface resistivity is measured as the surface resistivity of the conductive thin film layer 16 comprising the electric conductor 12. The surface resistivity of the radio wave reflector 11 in a flat state is the surface resistivity of the radio wave reflector 11 when the radio wave reflector 11 is placed on a flat placement surface. The term “flat” means a state in which there is no unevenness and no curves, or a state in which the curvature radius at any point on the surface is 1000 mm or more even if there is unevenness.

The surface resistivity means surface resistance per cm² (one square centimeter). The surface resistivity can be measured in accordance with the four-terminal method specified in JISK6911 by bringing measurement terminals into contact with the surface of the conductive thin film layer 16 described later. If the conductive thin film layer 16 is protected with a resin sheet etc. and is not exposed, the measurement may be performed by an eddy current method using a non-contact resistance measurement instrument (product name: EC-80P or an equivalent thereof, produced by Napson Corporation).

In the radio wave reflector 11, the change rate R in surface resistivity when curved is −10% or more and 10% or less. The change rate R in surface resistivity when curved is the percentage of change of surface resistivity R2 of the radio wave reflector 11 curved along the surface of a member having a curved surface with a curvature radius of 200 mm with respect to surface resistivity R1 of the radio wave reflector 11 in a flat state. The change rate R in surface resistivity when curved is determined by the following formula.

R(%)=(R2−R1)/R1×100

The reflection intensity of radio waves changes depending on surface resistivity. However, since the change rate R in surface resistivity when the radio wave reflector 11 is curved is −10% or more and 10% or less, sufficient reflection intensity of radio waves can be achieved even when the radio wave reflector 11 is curved, as in when it is in a flat state.

The radio wave reflector 11 preferably has a flexural modulus of 0.05 GPa or more and 4 GPa or less. Flexural modulus is a value that indicates how much flexural stress can be withstood and is defined in JIS K7171. When the radio wave reflector 11 has a flexural modulus within the above range, the radio wave reflector 11 has flexibility and can be attached to a curved surface with a curvature radius of 200 mm or more by curving the radio wave reflector 11 without breaking the radio wave reflector 11. The flexural modulus is measured in accordance with JIS K7171. Flexibility refers to the property of being flexible under ordinary temperature and ordinary pressure, and capable of undergoing deformation, such as bending, curving, or folding, without shearing or rupture even when force is applied.

The radio wave reflector 11 preferably has a Young's modulus of 0.01 GPa or more and 80 GPa or less. Young's modulus is the elastic modulus of a solid when stretched by applying tension thereto in one direction, is also called “tensile elastic modulus,” and is defined in JIS K7161-2014. When the radio wave reflector 11 has a Young's modulus within the above range, the radio wave reflector 11 can be easily deformed and can be attached to a curved surface with a curvature radius of 200 mm or more by curving the radio wave reflector 11 without breaking the radio wave reflector 11. The Young's modulus is measured in accordance with JIS K7127-1999.

The radio wave reflector 11 has at least flexibility to the extent that it can be attached along a curved surface with a curvature radius of 200 mm or more. It is preferred that the radio wave reflector 11 has flexibility to the extent that it can be attached along a curved surface with a curvature radius of 100 mm or more.

The radio wave reflector 11 may have plasticity. Plasticity refers to the property of being deformable by applying external pressure, and retaining the deformed shape even after the force is removed when deformation beyond the elastic limit is imparted by applying pressure. All of the synthetic resins forming the substrate layer 13, the adhesive layer 14, and the protective layer 15 may have plasticity, or at least one of the substrate layer 13, the adhesive layer 14, and the protective layer 15 may have plasticity.

In the radio wave reflector 11, the change of yellowness index, which is the difference between the yellow index after a heat and humidity resistance test and the yellow index before the heat and humidity resistance test, is 3 or less. Yellow index, also called the “yellowness index,” refers to the degree to which the hue is away from colorless or white to the yellow direction. The yellow index is determined by a method in accordance with JISK7373.

The heat and humidity resistance test is a test in which the radio wave reflector 11 is allowed to stand in a constant temperature and humidity chamber adjusted to a temperature of 60° C. and a humidity of 95% RH (relative humidity: 95%) for 500 hours, then removed from the constant temperature and humidity chamber, and allowed to stand at ordinary temperature for 4 hours, and the properties and condition of the radio wave reflector 11 is checked.

Before and after the heat and humidity resistance test, the radio wave reflector 11 is caused to specularly reflect an incident wave having a frequency of 2 GHz or more and 300 GHz or less at a predetermined incident angle of the incident wave in the range of 15 degrees or more and 75 degrees or less, preferably at 45 degrees, more preferably at all of the angles in the range of 15 degrees or more and 75 degrees or less. In this case, the difference between the intensity of the reflective wave of the radio wave reflector 11 after the heat and humidity resistance test and the intensity of the reflective wave of the radio wave reflector 11 before the heat and humidity resistance test is within 3 dB at one or more frequencies of incident wave. Preferably, in the entire frequency band of 2 GHz or more and 300 GHz or less, the difference in the intensity of the reflective wave of the radio wave reflector 11 before and after the heat and humidity resistance test is within 3 dB.

In the radio wave reflector 11, the change rate r in surface resistivity before and after the heat and humidity resistance test (also referred to as “the change rate r in surface resistivity during the heat and humidity resistance test”) is 20% or less. The change rate r in surface resistivity during the heat and humidity resistance test is the percentage of change of surface resistivity r2 after the heat and humidity resistance test with respect to surface resistivity r1 before the heat and humidity resistance test. The change rate r in surface resistivity during the heat and humidity resistance test is determined by the following formula.

r=(r1−r2)/r1×100

The reflection intensity of radio waves changes depending on surface resistivity. However, since the change rate r in surface resistivity of the radio wave reflector 11 during the heat and humidity resistance test is 20% or less, the radio wave reflector 11 achieves sufficient reflection intensity of radio waves without significantly decreasing reflection intensity even after the heat and humidity resistance test.

When a pencil hardness test is performed on the radio wave reflector 11, the pencil hardness at a surface load of 500 g on the protective layer 15 is preferably “F” or higher, more preferably “H” or higher, and even more preferably “4H” or higher. “Pencil hardness test” as used herein is a test in accordance with JIS K 5600-5-4 (1999). If the load applied to the surface during the pencil hardness test is 500 g±10 g, the load is included in the “surface load of 500 g.” When a pencil hardness test is performed on the protective layer 15, the pencil hardness at a surface load of 500 g on the protective layer 15 may be F or higher.

In addition, in the radio wave reflector 11, the reduction rate of the adhesive strength of the protective layer 15 to the layer to be adhered after the heat and humidity resistance test is preferably 50% or less, more preferably 45% or less, and even more preferably 40% or less. The term “the layer to be adhered” as used herein means a layer in direct contact with the target layer. The layer to be adhered of the protective layer 15 is the adhesive layer 14 in this embodiment. The adhesive strength is measured by a tensile adhesive strength test in accordance with JIS K 6849 (1994).

In the radio wave reflector 11, in a virtual plane including the incident direction of the incident wave and the reflection direction of the reflective wave, the kurtosis of distribution of intensity of the reflective wave at each reception angular position is preferably −0.4 or less when the reception angular positions of the reflective wave are varied within an angle range α of −15 degrees or more and +15 degrees or less with respect to the specular reflection direction of the radio wave. The kurtosis is more preferably −1.0 or less, even more preferably −1.1 or less, and still even more preferably −1.2 or less. The lower limit of the kurtosis is not particularly limited and is typically about −0.5. The virtual plane can also be referred to as a plane including the reflection point 11a on the reflective surface of the reflector, the radio wave source 20, and the receiver 21 of the reflective wave. The kurtosis is determined with the radio wave reflector 11 being in a flat state.

Kurtosis is a statistic that expresses how much a distribution deviates from the normal distribution, and indicates the degree of peakedness and the heaviness of its tail. As shown in FIG. 1, it is assumed that a radio wave output from the radio wave source 20 is incident on the radio wave reflector 11 at a predetermined incident angle θ1. Then, a reflection intensity x is measured by moving a reception angular position i of the receiver 21 by a predetermined angle each (e.g., 5 degrees each) from the specular reflection direction of the radio wave with the reflection point 11a being set as the center, within the angle range α of −15 degrees or more and +15 degrees or less with respect to the specular reflection direction of the radio wave. The reception angular position i of the receiver 21 is located on an arc from the reflection point 11a set as the center. The kurtosis is calculated according to the following formula when the average value of the values of the reflection intensity at each reception angular position i
xᵢ(i: 1, 2, . . . , n)
is
\tilde{x}
, and
the standard deviation is s.

$$Kurtosis = \frac{n ( n + 1 )}{( n - 1 ) ( n - 2 ) ( n - 3 )} {\sum }_{i = 1}^{n} \frac{{( {x}_{i} - \overline{x} )}^{4}}{{S}^{4}} - \frac{3 {( n - 1 )}^{2}}{( n - 2 ) ( n - 3 )} \qquad Formula 1$$

Negative kurtosis values indicate that the distribution of intensity data in terms of each angular position is flatter than the normal distribution; i.e., the data values spread from around the mean value and the tail of the distribution is wider. The smaller the kurtosis value, the flatter the distribution. In this embodiment, the kurtosis is set to −0.4 or less; thus, the difference in the reflection intensity between the reception angular positions is made small within the angle range α of ±15 degrees with respect to the specular reflection direction of a radio wave.

The radio wave reflector 11 as a whole may have visible-light transmission properties, i.e., it may be transparent. As described in detail later, the radio wave reflector 11 comprises at least a substrate layer 13 and a conductive thin film layer 16 comprising an electric conductor 12, and preferably further comprises an adhesive layer 14 and a protective layer 15. The substrate layer 13, the adhesive layer 14, and the protective layer 15 may each be formed with a resin that has visible-light transmission properties, and the electric conductor 12 of the conductive thin film layer 16 may be formed to have such a thickness as to exhibit visible-light transmission properties, The term “transparent” used here means that one side of the radio wave reflector 11 can be seen from the other side, includes translucent, and is not limited to completely transparent, in which the total light transmittance is 100%. Further, the radio wave reflector 11 may be colored. For standard illuminant D65, the radio wave reflector 11 has a total light transmittance of 65% or more, preferably 80% or more, more preferably 85% or more, and even more preferably 90% or more. The total light transmittance is a ratio of the total transmitted luminous flux to the parallel incident luminous flux of a test piece and is measured in accordance with JIS K 7375:2008.

As shown in FIG. 3, in this embodiment, the overall shape of the radio wave reflector 11 is a square in plan view, and the one-side length L10 is preferably 20 cm or more and 400 cm or less. Since radio waves having a frequency of 2 GHz or more and 300 GHz or less are attenuated by distance, the one-side length L10 is preferably set to 20 cm or more in order to achieve reflection with sufficient intensity at all points within the practical distance from the radio wave source 20. The upper limit of the one-side length L10 is not particularly limited; from a manufacturing standpoint, the upper limit is preferably 400 cm or less. The overall shape of the radio wave reflector 11 is not limited to a square and may be a rectangle or a polygon, such as a triangle, pentagon, or hexagon. In this case, the length of the shortest side is set to 20 cm or more and 400 cm or less. Alternatively, the shortest distance between one vertex and the opposite side or between one side and the opposite side may be set to 20 cm or more and 400 cm or less. If the overall shape of the radio wave reflector 11 is circular, the diameter is set to 20 cm or more and 400 cm or less. If the overall shape of the radio wave reflector 11 is elliptical, the short diameter is set to 20 cm or more and 400 cm or less. If the overall shape of the radio wave reflector 11 is sector, the length of the arc or radius, whichever is shorter, is set to 20 cm or more and 400 cm or less. The overall shape of the radio wave reflector 11 may also be cylindrical, conical, or other three-dimensional shapes. The radio wave reflector 11 has an overall shape and size that enable reflection of radio waves with a reflection intensity of −30 dB or more relative to the incident wave, and the shape and size are appropriately selected according to embodiments in which the radio wave reflector 11 is used.

The thickness L11 of the radio wave reflector 11 is preferably set to 0.01 mm or more and 0.5 mm or less. The thickness of each of the substrate layer 13, the conductive thin film layer 16, the adhesive layer 14, and the protective layer 15 is set such that the thickness L11 of the radio wave reflector 11 is 0.5 mm or less. The thickness L11 of the radio wave reflector 11 is set to a thickness such that the radio wave reflector 11 has flexibility and such that when the radio wave reflector 11 is curved by applying an external force to the radio wave reflector 11, the force is not concentrated on the electric conductor 12 of the conductive thin film layer 16 and can be distributed to the substrate layer 13, the adhesive layer 14, and the protective layer 15.

The radio wave reflector 11 has at least flexibility to the extent that it can be attached along a curved surface with a curvature radius of 200 mm or more. It is preferred that the radio wave reflector 11 has flexibility to the extent that it can be attached along a curved surface with a curvature radius of 100 mm or more. The thickness L11 of the radio wave reflector 11 is the sum of the thickness L3 of the conductive thin film layer 16 and the thickness L8 of the substrate layer 13, or the sum of the thickness L3 of the conductive thin film layer 16, the thickness L8 of the substrate layer 13, the thickness L4 of the adhesive layer 14, and the thickness L5 of the protective layer 15. However, since the thickness L3 of the conductive thin film layer 16 is very thin compared to each of the thicknesses L8, L4, and L5 of the substrate layer 13, the adhesive layer 14, and the protective layer 15, the thickness L3 of the conductive thin film layer 16 may be ignored when calculating the thickness L11 of the radio wave reflector 11.

The thickness L11 of the radio wave reflector 11, the thickness L3 of the conductive thin film layer 16, the thickness L8 of the substrate layer 13, the thickness L4 of the adhesive layer 14, and the thickness L5 of the protective layer 15 are each determined by measuring any multiple points and calculating the average value of the obtained measurement values. The thickness L11, thickness L3, thickness L8, thickness L4, and thickness L5 may be measured, for example, by a reflectance spectroscopic film thickness analyzer (e.g., F3-CS-NIR produced by Filmetrics Japan, Inc.) as a measuring instrument.

### Configuration of Radio Wave Reflector 11

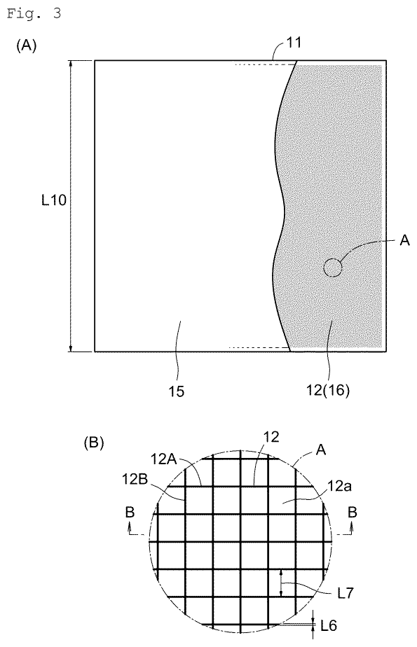

The radio wave reflector 11 according to one embodiment is explained with reference to FIGS. 2 and 3. The radio wave reflector 11 may comprise a conductive thin film layer 16 comprising an electric conductor 12, a substrate layer 13 comprising a substrate and laminated to the conductive thin film layer 16, a protective layer 15 comprising a protective material for protecting the conductive thin film layer 16, and an adhesive layer 14 comprising an adhesive for bonding the conductive thin film layer 16 and the protective layer 15. The radio wave reflector 11 may comprise the conductive thin film layer 16, which comprises the electric conductor 12, and a resin for holding the electric conductor 12 in a sheet shape. At least one of the substrate layer 13, which comprises the substrate, the protective layer 15, which comprises the protective material for protecting the conductive thin film layer 16, and the adhesive layer 14, which comprises the adhesive for bonding the conductive thin film layer 16 and the protective layer 15, may be formed of resin. In the embodiment shown in FIG. 2, in the radio wave reflector 11, the conductive thin film layer 16 is laminated on the substrate layer 13; and on the conductive thin film layer 16, the adhesive layer 14 and the protective layer 15 are laminated sequentially.

In the following explanations, the up-down direction is defined based on FIG. 2, and the vertical-horizontal direction is defined based on FIG. 3; however, the up-down direction and vertical-horizontal direction are used for illustrative purposes and do not define the up-down direction and vertical-horizontal direction at the time of use, such as installation of the radio wave reflector 11 in a building. Further, FIGS. 1 to 11 are not drawn to actual scale. Additionally, in FIG. 3(A), the adhesive layer 14 and the protective layer 15 are omitted in part of the radio wave reflector 11.

### Substrate Layer 13

In this embodiment, the outer shape of the substrate layer 13 is a square in plan view. The shape is not limited to this and may be rectangular, circular, oval, sector, polygonal, three-dimensional, etc. according to the overall shape of the radio wave reflector 11. The substrate of the substrate layer 13 may be a sheet of a synthetic resin. Examples of synthetic resins include one or more members selected from the group consisting of PET (polyethylene terephthalate), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin. Although the thickness L8 of the substrate layer 13 (the length in the up-down direction in FIG. 2) is set to 0.13 mm in this embodiment, the thickness is not limited to this value and is set appropriately according to embodiments in which the radio wave reflector 11 is used. In addition to the substrate, the substrate layer 13 may comprise any substance such as a synthetic resin, and any component.

### Conductive Thin Film Layer 16

In the conductive thin film layer 16, it is preferable that one or a plurality of linear electric conductors 12 are formed as a thin film on the upper surface of the substrate layer 13. The electric conductor 12 is preferably composed of, for example, silver (Ag). However, the electric conductor 12 may be composed of any metal, metal compound, or alloy that has free electrons. Examples include not only silver, but also gold (Au), copper (Cu), platinum (Pt), zinc (Zn), iron (Fe), tin (Sn), lead (Pb), aluminum (Al), cobalt (Co), indium (In), nickel (Ni), chromium (Cr), titanium (Ti), antimony (Sb), bismuth (Bi), thallium (Tl), germanium (Ge), cadmium (Cd), silicon (Si), tungsten (W), molybdenum (Mo), indium tin oxide (ITO), and alloys (e.g., alloys containing nickel, chromium, and molybdenum). Examples of alloys containing nickel, chromium, and molybdenum include various grades of alloys, such as Hastelloy B-2, B-3, C-4, C-2000, C-22, C-276, G-30, N, W, and X. In addition to the electric conductor 12, the conductive thin film layer 16 may comprise any substance such as a synthetic resin, and any component.

In this embodiment, as shown in FIG. 3(B), one or a plurality of linear electric conductors 12 are arranged to surround regions 12a without the electric conductor 12. That is, the electric conductors 12 and the regions 12a without the electric conductor 12 are periodically arranged at predetermined intervals. The electric conductors 12 and the regions 12a without the electric conductor 12 together form a thin film. The interval between the adjacent regions 12a without the electric conductor 12 may be a length equal to or greater than the line width L6 of the electric conductor 12. Linear means that the length in the longitudinal direction is at least 3000 times longer than the length in the direction perpendicular to the longitudinal direction. In the example shown in FIG. 3(B), the electric conductors 12 are arranged at equal intervals along the vertical direction and the horizontal direction, and the region 12a without the electric conductor 12 surrounded by the electric conductors 12 is a square. That is, the regions 12a without the electric conductor 12 are arranged at an interval that is equal to the line width L6 of the electric conductor 12. At the intersections at which the electric conductor 12 (12A) along the horizontal direction and the electric conductor 12 (12B) along the vertical direction overlap, the electric conductors 12A and 12B are electrically conducting. The line width L6 of the electric conductor 12 is preferably set to 0.05 μm or more and 15 μm or less. The interval L7 between the adjacent electric conductors 12 along the vertical direction or the horizontal direction (the one-side length of the square region 12a without the electric conductor 12) is set to be larger than the wavelengths of visible light and smaller than the wavelengths of the radio waves reflected from the radio wave reflector 11. In this example, the interval L7 is set to 2 μm or more and 10 cm or less. The interval L7 is more preferably 20 μm or more and 1 cm or less, even more preferably 25 μm or more and 1 mm or less, and still even more preferably 30 μm or more and 250 μm or less.

The thickness (film thickness) L3 of the electric conductor 12 is preferably a thickness that is sufficient to exhibit visible-light transmission properties. The thickness L3 of the electric conductor 12 is preferably 0.05 μm or more and 10 μm or less. The thickness L3 is preferably 5 nm or more from the viewpoint of ensuring appropriate radio wave intensity.

The surface roughness Sa of the conductive thin film layer 16 is not particularly limited, and is preferably 1 μm or more and 7 μm or less, and more preferably 1.03 μm or more and 6.72 μm or less. A surface roughness Sa within these ranges facilitates diffuse reflection of radio waves.

The surface roughness Sa is determined by the arithmetical mean height according to ISO 25178 and measured in accordance with ISO 25178. By using a laser microscope (product name: VK-X1000/1050, produced by Keyence Corporation, or an equivalent thereof), the surface roughness Sa of the conductive thin film layer 16 can be determined by measuring the surface roughness at multiple points on the surface of the conductive thin film layer 16 and calculating the average value of the obtained measurement values. The electric conductor 12 and the substrate layer 13 may be used as a measurement target. In this embodiment, the conductive thin film layer 16 comprises a plurality of electric conductors 12, the surface roughness is measured at multiple points on each electric conductor 12, and the average value of the measurement values is defined as the surface roughness Sa of the conductive thin film layer 16.

The conductive thin film layer 16 preferably has a coverage of 1% or more and 50% or less, and more preferably 1% or more and 10% or less. Coverage refers to the percentage of area occupied by the electric conductor 12 per unit area in plan view. In the embodiment shown in FIGS. 2 and 3, the coverage refers to the percentage of the area of the electric conductor 12 in plan view in the area of the substrate layer 13 in plan view. The coverage can also refer to the area of the substrate layer 13 covered by the electric conductor 12 with respect to the area of the substrate layer 13 in plan view. The coverage is measured using, for example, a scanning electron microscope (SEM), transmission electron microscope (TEM), or optical microscope.

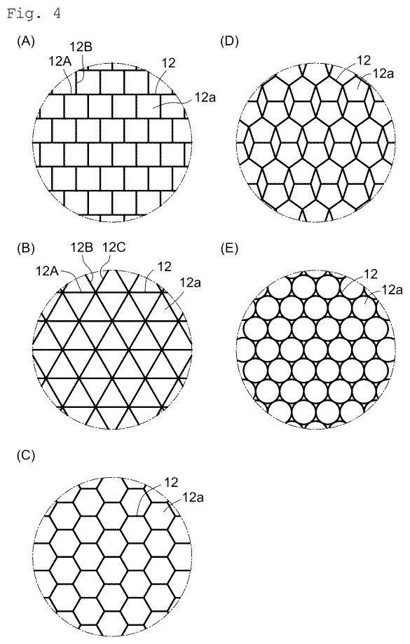

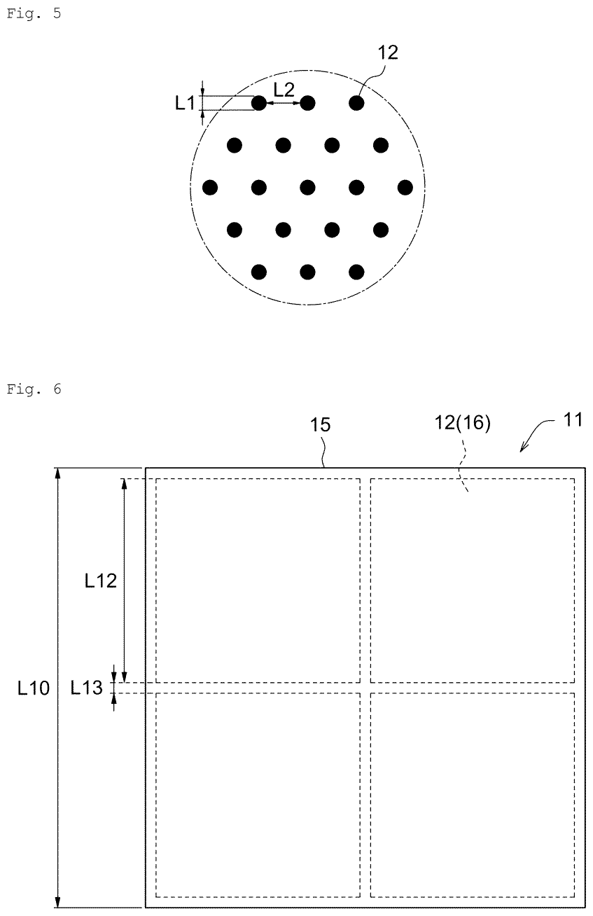

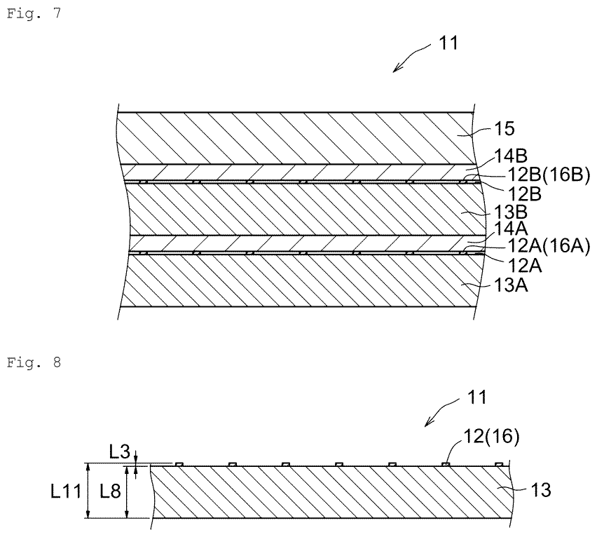

In the arrangement of the electric conductor 12 shown in FIG. 3(B), the shape of the region 12a without the electric conductor 12 is a square. Alternatively, for example, the interval between the adjacent electric conductors 12A extending in the horizontal direction may be different from the interval between the adjacent electric conductors 12B extending in the vertical direction, and the shape of the region 12a without the electric conductor 12 may be rectangular. It is also possible to arrange the electric conductors 12 according to the arrangement patterns shown in FIGS. 4(A) to 4(E). In FIG. 4(A), a plurality of the electric conductors 12A extending in the horizontal direction are arranged in the vertical direction at predetermined intervals, and a plurality of the electric conductors 12B extending in the vertical direction are arranged in a staggered manner between the electric conductors 12A, which are adjacent to each other in the vertical direction. Staggered means a state in which a plurality of the electric conductors 12B extending in the vertical direction are arranged at predetermined intervals in the horizontal direction, and a plurality of the electric conductors 12B forming a single row are positioned between a plurality of the electric conductors 12B forming rows that are adjacent in the vertical direction to the row, whereby the electric conductors 12B forming rows alternately are arranged in a straight line. In FIG. 4(B), the electric conductors 12A extend in the horizontal direction, the electric conductors 12B and 12C extend along oblique directions symmetrically inclined with respect to the horizontal direction, and the electric conductors 12B and 12C intersect with each other on the electric conductors 12A. Accordingly, the shape of the region 12a without the electric conductor 12 is an equilateral triangle. Instead of an equilateral triangle, the shape of the region 12a without the electric conductor 12 may be an isosceles triangle or a triangle having three sides of different lengths. In FIG. 4(C), the regions 12a without the electric conductor 12 surrounded by the linear electric conductors 12 and having a regular hexagonal shape are periodically arranged. In FIG. 4(D), the regions 12a without the electric conductor 12 surrounded by the linear electric conductors 12 and having a regular pentagonal shape are periodically arranged. In FIG. 4(E), the regions 12a without the electric conductor 12 surrounded by the linear electric conductors 12 and having a circular shape are periodically arranged. FIGS. 4(A) to 4(E) show only the electric conductors 12.

Examples of the method for producing the conductive thin film layer 16 having the arrangement patterns shown in FIGS. 3(B) and 4 include a method comprising forming a conductive film, forming a pattern by etching, and taking out a conductive thin film body having the pattern; and a method comprising applying a photosensitive resist to a base film having a lift-off layer, forming a pattern by a photolithography method, filling the pattern portion with an electric conductor, and then taking out a conductive thin film body having the pattern. The method for producing the conductive thin film layer 16 is not limited to the above methods, and examples of methods that can be used for forming the conductive thin film layer 16 include a method of bonding a metal thin film and a method of depositing a metal.

### Another Embodiment of Conductive Thin Film Layer 16

FIG. 5 shows another embodiment of the conductive thin film layer 16. In the embodiment shown in FIG. 5, a plurality of electric conductors 12 are periodically arranged in a sheet shape (thin film shape) on the upper surface of the substrate layer 13. In this embodiment, electric conductors 12 that are circular in plan view are used. The diameter L1 and the shortest distance (interval) L2 between the adjacent electric conductors 12 are set according to the frequency band of radio waves to be reflected. In this embodiment, the diameter L1 and the interval L2 are set such that radio waves with a frequency of 20 GHz or more and 300 GHz or less, which is the frequency band used in, in particular, the fifth-generation mobile communication system (5G), are reflected. However, the diameter L1 and the interval L2 are not limited thereto and may be set such that the electric conductor 12 reflects radio waves with a frequency of 2 GHz or more and 300 GHz or less. The diameter L1 of each electric conductor L2 may be 0.7 mm or more and 800 mm or less, and the interval L2 may be 1 μm or more and 1000 μm or less. The number of the electric conductors 12 is appropriately set according to the size (area) of the substrate layer 13. Sheet shape means a shape in which the length in the longitudinal direction is substantially the same as or less than 3000 times the length in the direction perpendicular to the longitudinal direction.

The shape of the electric conductor 12 is not limited to a circle, and may be any shape. The shape is preferably such that a periodic arrangement is possible in which a side of one electric conductor 12 and a side of adjacent electric conductors 12 are parallel while the intervals between one electric conductor 12 and all of adjacent electric conductors 12 are equal. For example, the shape may be a square, rectangle, triangle, or hexagon. In this case, the length of the shortest side of the electric conductor 12, the shortest distance between one vertex and the opposite side of the electric conductor 12, or the shortest distance between one side and the opposite side of the electric conductor 12 may be set to 0.005 μm or more and 100 mm or less, and preferably 0.1 μm or more and 1000 μm or less. Other configurations and functions are the same as those in the embodiment shown in FIGS. 2 and 3, and the same reference numerals are used to refer to corresponding configurations to omit the detailed descriptions thereof.

### Another Embodiment of Conductive Thin Film Layer 16

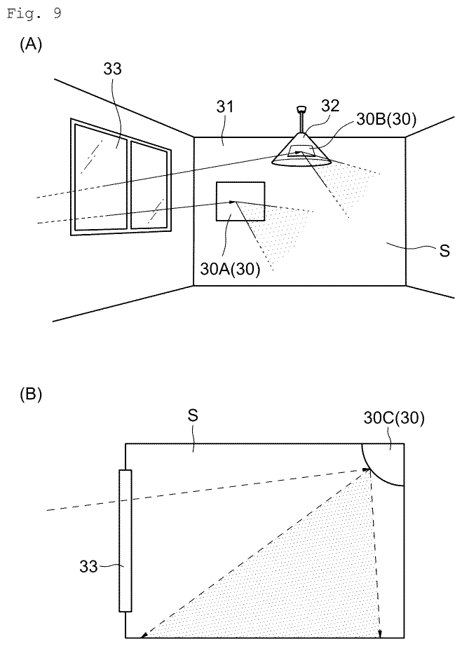

The conductive thin film layer 16 may have, for example, a metamaterial structure, In the metamaterial structure, the electric conductors 12 in a sheet shape as dielectrics are arranged periodically at equal intervals. Due to this periodic arrangement structure, the metamaterial structure has a negative permittivity, and reflect radio waves in a specific frequency band that is determined based on the periodic interval. The shape of each electric conductor 12 is not limited and may be the shape described above. For example, as shown in FIG. 6, each electric conductor 12 may have a square shape. In the electric conductor 12, the one-side length L12 and the interval L13 between the adjacent electric conductors 12 may be set so as to reflect radio waves with a frequency of 2 GHz or more and 300 GHz or less. In this case, the one-side length L12 of the electric conductor 12 may be 0.7 mm or more and 800 mm or less, and the interval L13 may be 1 μm or more and 1000 μm or less. The thickness L3 of the electric conductor 12 is preferably 350 nm (0.35 μm) or less, more preferably 100 nm or less, and even more preferably 50 nm or less. The number of the electric conductors 12 is appropriately set according to the size (area) of the substrate layer 13. In an example, four electric conductors 12 in total may be formed on the substrate layer 13, i.e., two vertically and two horizontally, according to the size of the substrate layer 13. In this case, the one-side length L12 of each electric conductor 12 is set to 77.460 mm, the interval L13 between the adjacent electric conductors 12 is set to 100 μm, and the thickness L3 is set to 350 nm (0.35 μm) or less. The conductive thin film layer 16 is not limited to one having a metamaterial structure, and may be any of a metallic nanowire lamination film, multilayer graphene, or partially exfoliated graphite. In addition to the electric conductor, the conductive thin film layer 16 may comprise any substance such as a synthetic resin, and any component.

### Adhesive Layer 14

The adhesive layer 14 is configured to adhere the protective layer 15 on the substrate layer 13 and the conductive thin film layer 16 and is composed of an adhesive. The adhesive layer 14 has a size corresponding to the substrate layer 13 in plan view. The adhesive of the adhesive layer 14 for use may be a synthetic resin or a rubber adhesive sheet. Examples of synthetic resins include an acrylic resin, a silicone resin, and a polyvinyl alcohol resin. The thickness L4 of the adhesive layer 14 is preferably set to 5 μm or more and 500 μm or less. In addition to the adhesive, the adhesive layer 14 may comprise any substance such as a synthetic resin, and any component.

The adhesive layer 14 preferably comprises a synthetic resin material having a dielectric loss tangent (tan δ) of 0.018 or less. The lower the dielectric loss tangent, the more preferable it is. The dielectric loss tangent is typically 0.0001 or more. The dielectric loss tangent represents the degree of electrical energy loss in a dielectric. The electrical energy loss is greater in a material having a greater dielectric loss tangent. The use of the adhesive layer 14 having a dielectric loss tangent of 0.018 or less can reduce the loss of electrical energy of radio waves in the radio wave reflector 11, and can further increase the reflection intensity.

The synthetic resin material of the adhesive layer 14 preferably has a relative permittivity that varies according to the frequency of an electric field. The relative permittivity is a ratio of the permittivity of a medium (the synthetic resin material in this embodiment) to the permittivity of vacuum. Since the relative permittivity varies according to an electric field, the intensity of the reflective wave can be increased in an electric field at a specific frequency. The relative permittivity preferably varies between 1.5 or more and 7 or less, and more preferably between 1.8 or more and 6.5 or less. The dielectric loss tangent and the relative permittivity are measured by a known method (e.g., a cavity resonator method or a coaxial resonator method) using a measuring instrument (e.g., TOYO Corporation, model number: TTPX table-top cryogenic probe station or an MIA-5M material/impedance analyzer).

Not only the synthetic resin material constituting the adhesive layer 14, but also the synthetic resin material constituting the substrate layer 13 and the protective layer 15, may have a dielectric loss tangent of 0.018 or less, and may have a relative permittivity that varies according to an electric field.

### Protective Layer 15

The protective layer 15 has a size corresponding to the substrate layer 13 in plan view, protects the electric conductor 12, and is composed of a protective material. The protective material of the protective layer 15 for use may be a sheet (film) of a synthetic resin. Examples of synthetic resins include one or more members selected from the group consisting of PET (polyethylene terephthalate), COP (cycloolefin polymer), polyethylene, polypropylene, polyvinyl chloride, polystyrene, polymethyl methacrylate, polyester, polyformaldehyde, polyamide, polyphenylene ether, vinylidene chloride, polyvinyl acetate, polyvinyl acetal, AS resin, ABS resin, acrylic resin, fluororesin, nylon resin, polyacetal resin, polycarbonate resin, polyamide resin, and polyurethane resin. The thickness L5 of the protective layer 15 is preferably set to 0.02 mm or more and 0.30 mm or less. In addition to the protective material, the protective layer 15 may comprise any substance such as a synthetic resin, and any component.

In the protective layer 15, for example, at least one of the upper surface (outer surface) and lower surface (surface in contact with the adhesive layer 14) of the film of a synthetic resin in FIG. 2 may be subjected to anti-glare treatment or anti-reflection treatment.

Anti-glare treatment (also referred to as “AG treatment” or “non-glare treatment”) refers to a treatment in which an uneven shape is formed on at least one surface of the protective layer 15 to scatter light, thereby suppressing glare from a light source, such as lighting, on the protective layer 15. Examples of the method for performing anti-glare treatment include a method comprising applying a binder resin in which fine particles are dispersed to the surface of a film. Known methods, such as sandblasting and chemical etching, may also be used.

Anti-reflection treatment (also referred to as “AR treatment”) refers to a treatment in which an antireflection coating is formed on at least one surface of a film, and light reflected from the surface of the antireflection coating and light reflected from the interface between the antireflection coating and the film are attenuated by interference to suppress glare from a light source, such as lighting. The antireflection coating may be a single layer or may be composed of thin films having different refractive indices alternately laminated, and a known antireflection coating is used.

The protective layer 15 may be a layer in which a film subjected to anti-glare treatment or anti-reflection treatment is attached to one or both surfaces of a film of a synthetic resin.

The protective layer 15 preferably has a water vapor transmission rate of 20 g/m²·24 h or less, more preferably 16 g/m²·24 h or less, even more preferably 12 g/m²·24 h or less, and still even more preferably 10 g/m²·24 h or less, at a temperature of 40° C. and a humidity of 90% RH (relative humidity). When the protective layer 15 has a water vapor transmission rate of 20 g/m²·24 h or less at a temperature of 40° C. and a humidity of 90% RH (relative humidity), there are advantages such that the conductive thin film layer 16 is less likely to corrode and that the surface resistivity of the conductive thin film layer 16 is less likely to increase. In the present specification, the water vapor transmission rate is measured by a test method in accordance with JIS Z 0208 (1976).

### Another Embodiment

FIG. 7 shows another embodiment of the present invention. The radio wave reflector 11 shown in FIG. 7 is a laminated body in which two layers, i.e., the electric conductors 12A and 12B are laminated in the up-down direction with the substrate layers 13A and 13B, which are resins. In the lamination, the electric conductors 12A formed on the substrate layer 13A and the electric conductors 12B formed on the substrate layer 13B are aligned to overlap each other in plan view. Alternatively, the arrangement patterns of the conductive thin film layers 16A and 16B in FIG. 7 may not overlap each other in plan view, and the conductive thin film layers 16A and 16B may have different arrangement patterns, The lower surface of the substrate layer 13B is bonded to the electric conductor 12A via the adhesive layer 14A, and the protective layer 15 is bonded to the electric conductor 12B via the adhesive layer 14B. In this embodiment, the Young's modulus is preferably 0.01 GPa or more and 80 GPa or less, and the thickness of the radio wave reflector is preferably 0.01 mm or more and 0.5 mm or less. The total light transmittance of the radio wave reflector 11 is 70%.

While radio waves incident on the radio wave reflector 11 are reflected from the electric conductor 12B of the first layer, part of the radio waves pass through the electric conductor 12B without being reflected from the electric conductor 12B. The radio waves that passed through the electric conductor 12B are reflected from the electric conductor 12A of the second layer. Accordingly, by laminating a plurality of the electric conductors 12 in the up-down direction, radio waves that passed through the electric conductor 12B of the upper layer can be reflected from the electric conductor 12A of the lower layer, and the reflection intensity of the radio wave reflector 11 can be kept higher compared with the case where the electric conductor 12 comprises only a single layer. In addition, the kurtosis of distribution of the reflection intensities within the angle range α of ±15 degrees with respect to the specular reflection direction of radio waves can be further reduced, making the difference in the reflection intensity between the angular positions within the angle range α small. Further, the use of the two adhesive layers 14A and 14B can further reduce the value of the dielectric loss tangent as compared with the embodiments shown in FIG. 2, making it possible to keep the reflection intensity higher. Other configurations and functions are the same as those in the embodiment shown in FIGS. 2 and 3, and the same reference numerals are used to refer to corresponding configurations to omit the detailed descriptions thereof.

In the embodiment shown in FIG. 7, two layers of the electric conductors 12 formed on the respective substrate layers 13 are laminated. Alternatively, three layers or more thereof may be laminated. As the number of the layers of the electric conductors 12 increases, the reflection intensity increases; however, since the overall thickness of the radio wave reflector 11 increases, the flexibility decreases, and the visible-light transmission properties also decrease. For this reason, the number of the layers is set appropriately according to the intended use etc.; for example, the number of the layers is increased, in particular, when the radio wave reflector 11 is installed at a location that does not require flexibility and transparency.

### Another Embodiment

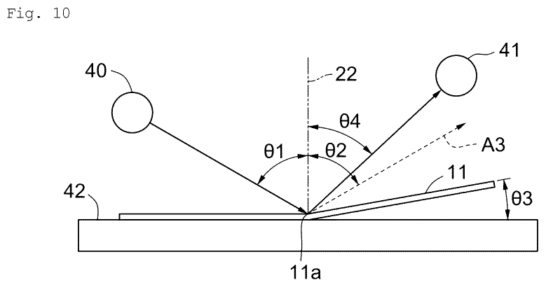

FIG. 8 shows another embodiment of the radio wave reflector 11. In the embodiment shown in FIG. 8, the radio wave reflector 11 comprises a conductive thin film layer 16 composed of a plurality of linear electric conductors 12 that are the same as in the embodiment shown in FIGS. 2 and 3, and a substrate layer 13, but does not comprise an adhesive layer 14 and a protective layer 15. In this embodiment, the flexural modulus is preferably 0.05 GPa or more and 4 GPa or less, the Young's modulus is preferably 0.01 GPa or more and 80 GPa or less, and the thickness of the radio wave reflector is preferably 0.01 mm or more and 0.5 mm or less. The total light transmittance of the radio wave reflector 11 is 70%. Other configurations and functions are the same as those in the embodiment shown in FIGS. 2 and 3, and the same reference numerals are used to refer to corresponding configurations to omit the detailed descriptions thereof.

In the embodiment shown in FIG. 8, the conductive thin film layer 16 is composed of a plurality of linear electric conductors 12. However, the conductive thin film layer 16 is not limited to this embodiment. For example, a single sheet of the electric conductor 12, which is a dielectric, may be formed in a square shape on substantially the entire upper surface of the substrate layer 13. In this case, the coverage is defined as the percentage of the area occupied by the electric conductor 12 per unit area in the portion at which the conductive thin film layer 16 is provided on the substrate layer 13, and the coverage is 100%. Alternatively, the size of the electric conductor 12 may be slightly smaller than the size of the substrate layer 13 in plan view such that the electric conductor 12 is not formed in the region close to the side edges of the substrate layer 13.

The conductive thin film layer 16 according to the embodiment shown in FIG. 8 may be composed of a plurality of sheets of electric conductors 12 arranged periodically at equal intervals as in the conductive thin film layer 16 according to the embodiment shown in FIG. 6. In this case, the plurality of the electric conductors 12 are arranged at predetermined intervals on substantially the entire upper surface of the substrate layer 13. The shape of the electric conductor 12 may be a square, a circle, a rectangle, a triangle, a polygon, or the like. The conductive thin film layer 16 may have a metamaterial structure. The conductive thin film layer 16 may be any of a metallic nanowire lamination film, multilayer graphene, or partially exfoliated graphite.

### Use

Any of the radio wave reflectors 11 described above may be included in a building material 30 and used. Examples of the building material 30 include, as shown in FIG. 9(A), materials that can be installed in a building as a decorative material 30A, such as wallpapers for wall surfaces, ceiling surfaces, and floor surfaces of rooms and corridors, wallpapers for partitions, and posters, or as a decorative material 30B, such as transparent stickers for light covers. By attaching decorative materials 30A, 30B including the radio wave reflector 11 to a wall surface 31 and a light cover 32, radio waves entering the room from the outside through a window 33 or the like are reflected by the decorative materials 30A, 30B provided on the wall surface 31 and the light cover 32. As a result, radio waves reach a wider area of the indoor space S, thus increasing the convenience of radio wave reception.

Alternatively, the radio wave reflector 11 may be formed to be present inside a member or a building material comprising a non-conductive material such as resin. For example, the wall surface 31 itself or the light cover 32 itself, which are building materials 30, may comprise a radio wave reflector 11. Further, the building material 30 is not limited to indoor walls and light covers, and may be, for example, partitions, pillars, lintels, outer walls of buildings, windows, and the like. For example, FIG. 9(B) is a plan view of the interior of a room. The building material 30 that is a radio wave reflector 11 is formed as a corner post 30C that has a curved surface at the corner of the room. Radio waves entering from a window 33 are reflected by the corner post 30C and thus reach a wider range of the indoor space S. FIGS. 9(A) and 9(B) show an application example of the building material 30 and are not intended to show the actual range of radio wave reflection.

### Evaluation Test

Examples 1 to 9 were prepared as radio wave reflectors 11. Examples 1 to 9 and Comparative Examples 1 to 4 were tested and evaluated for reflection direction-correcting properties and unevenness followability. However, the radio wave reflector 11 of the present invention is not limited to Examples 1 to 9.

### Explanation of Examples and Comparative Examples

Table 1 shows details of Examples 1 to 9 and Comparative Examples 1 to 4, and the results of the evaluation tests. In Table 1, Examples 1 to 9 and Comparative Examples 1 to 4 had any one of “Configuration A” to “Configuration D” and a “Metal Plate” as the configuration of the radio wave reflector. “Configuration A” is a configuration in which a substrate layer 13, a conductive thin film layer 16 (electric conductor 12), an adhesive layer 14, and a protective layer 15 are laminated in this order as in the embodiment shown in FIGS. 2 and 3. As the substrate layer 13 and the protective layer 15, synthetic resin material sheets formed of PET were used (Lumirror 50T60, produced by Toray Industries, Inc.; product No. 125-034 was used for the substrate layer 13 and protective layer 15 with a thickness of 0.13 mm, and product No. 188-034 was used for these layers with a thickness of 0.19 mm).

“Configuration B” is a configuration in which a conductive thin film layer 16 (electric conductor 12) is laminated on a substrate layer 13 as in the embodiment shown in FIG. 8. As the substrate layer 13, a synthetic resin material sheet formed of PTFE (fluororesin) (TOMBO No. 9000, produced by NICHIAS Corporation) was used.

“Configuration C” is a configuration in which a conductive thin film layer 16 (electric conductor 12) is laminated on a substrate layer 13 as in the embodiment shown in FIG. 8. As the substrate layer 13, a thin-film glass (G-Leaf, produced by Nippon Electric Glass Co., Ltd.) was used.

“Configuration D” is a configuration in which a substrate layer 13, a conductive thin film layer 16 (electric conductor 12), an adhesive layer 14, and a protective layer 15 are laminated in this order as in the embodiment shown in FIGS. 2 and 3. Configuration D is different from Configuration A in the substrate layer 13. As the substrate layer 13 in Configuration D, a synthetic resin material sheet formed of PEEK (polyetheretherketone) (Midfil NS, produced by Kurabo Industries, Ltd.) was used. Other configurations were the same as those of Configuration A.

The “Metal Plate” has a configuration of a single metal plate.

Table 1 states the arrangement pattern of the electric conductor 12 of the conductive thin film layer 16 as “conjugation type” or “isolation type.” As shown in FIG. 3(B) and FIG. 4, the “conjugation type” refers to a pattern in which one or a plurality of linear electric conductors 12 are arranged to surround multiple regions 12a without the electric conductor 12. That is, the electric conductor 12 and the region 12a without the electric conductor 12 are periodically arranged at predetermined intervals. As shown in FIG. 5 or 6, the “isolation type” refers to a pattern in which sheet-shaped electric conductors 12 are periodically arranged.

Table 1 states the shape of the arrangement patterns of the electric conductor 12 as “staggered,” “grid,” or “circular.” The “staggered” indicates that the arrangement pattern of the electric conductor 12 is of the “conjugation type” and that the electric conductor 12 is arranged in a staggered manner as shown in FIG. 4(A). The “grid” indicates that the arrangement pattern of the electric conductor 12 is of the “conjugation type” and that the electric conductors 12 are arranged at equal intervals along the vertical direction and the horizontal direction as shown in FIG. 3(B). The “circular” indicates that the arrangement pattern of the electric conductor 12 is of the “isolation type” and that the shape of each electric conductor 12 is circular as shown in FIG. 5.

Table 1 states adhesives for use in the adhesive layer 14 as “rubber” or “acrylic.” The “rubber” refers to a rubber adhesive, The rubber adhesive was obtained according to the following method. Specifically, 100 parts by weight of a rubber polymer (a mixture of 50 mass % of a styrene-(ethylene-propylene)-styrene block copolymer and 50 mass % of a styrene-(ethylene-propylene) block copolymer, styrene content: 15%, weight average molecular weight: 130000), 40 parts by weight of a synthetic resin (FMR-0150, produced by Mitsui Chemicals), 20 parts by weight of a softening agent (LV-100, produced by JX Nippon Oil & Energy Corporation), 0.5 parts by weight of an antioxidant (Adekastab AO-330, produced by ADEKA Co., Ltd.), and 150 parts by weight of toluene were placed in a reaction vessel equipped with a cooling tube, a nitrogen inlet tube, a thermometer, a dropping funnel, and a stirrer and stirred at 40° C. for 5 hours. The resulting mixture was applied to the protective layer 15 and dried. The rubber adhesive was thereby obtained.

The “acrylic” refers to an acrylic adhesive. The acrylic adhesive was obtained according to the following method. Specifically, 40 parts by mass of monofunctional long-chain urethane acrylate (PEM-X264, produced by AGC, Inc., molecular weight: 10000) and 60 parts by mass of acrylic monomer (35 parts by mass of 2-ethylhexyl acrylate (2EHA), 10 parts by mass of cyclohexyl acrylate (CHA), 10 parts by mass of 2-hydroxyethyl acrylate (2HEA), and 5 parts by mass of dimethylacrylamide (DMAA)) were mixed and stirred. Subsequently, 0.5 parts by mass of a crosslinking agent (1.6-hexanediol diacrylate (A-HD-N, produced by Shin Nakamura Chemical Co., Ltd.)) and a photopolymerization initiator (Omnirad 651 (produced by IGM Japan G.K.)) were added to the resulting (meth)acrylic acid ester copolymer solution, based on 100 parts by mass of the solids content of the (meth)acrylic acid ester copolymer. The mixture was then stirred and defoamed by vacuum. The acrylic adhesive was thereby obtained.

The adhesive layer 14 had a dielectric loss tangent of 0.002, i.e., no more than 0.018.

### Explanation of Examples and Comparative Examples

The radio wave reflector 11 produced as Example 1 had a configuration of “Configuration A.” The radio wave reflector 11 had a square shape in plan view. The radio wave reflector 11 had a one-side length L10 of 100 cm and a thickness L11 of 0.4 mm. The radio wave reflection intensity in a flat state (the “specular reflection intensity at 28.5 GHz in a flat state” in Table 1) was −24 dB, the Young's modulus was 0.08 GPa, the flexural modulus was 2.2 GPa, the surface resistivity was 1.7 Ω/□, and the change rate R in surface resistivity when curved was 4.3%. The total light transmittance of the radio wave reflector 11 was 89%, The substrate layer 13 had a thickness L8 of 0.13 mm. The arrangement pattern of the electric conductor 12 of the conductive thin film layer 16 was of the conjugation type, and the shape of the arrangement pattern was staggered. The line width L6 of the electric conductor 12 was 400 nm, the thickness L3 of the electric conductor 12 was 0.4 μm, and the interval L7 between adjacent electric conductors 12 was 100 μm (tolerance ±10 μm; the same applies below). The electric conductor 12 was a metal thin film formed of silver (Ag). The conductive thin film layer 16 had a surface roughness Sa of 1.1 μm and a coverage of 0.80%. The adhesive layer 14 was rubber. The thickness L4 of the adhesive layer 14 was 0.04 mm, and the thickness L5 of the protective layer 15 was 0.13 mm.

A method for producing the radio wave reflector 11 of Example 1 is described. First, an electric conductor 12 is formed on a substrate layer 13. A core layer of 0.01 μm or more and 3 μm or less is formed on one surface of a copper foil with a thickness of 5 μm or more and 200 μm or less, which has sufficient strength as a metal layer, by a method such as electrolytic or electroless plating. A conductive thin film layer 16 having a predetermined arrangement pattern is then formed on the surface of the core layer by a method such as electrolytic or electroless plating. Subsequently, the entire conductive thin film layer 16 is covered with a substrate layer 13. The substrate layer 13 is pre-coated with an adhesive. The copper foil and the core layer are then removed by etching. The electric conductor 12 is thereby formed on the substrate layer 13.

Using an adhesive layer 14, a protective layer 15 is attached to the radio wave reflecting material 12 on the side opposite to the side where the substrate layer 13 is present. Using the adhesive layer 14, the protective layer 15 is attached to the radio wave reflecting material 12 on the substrate layer 13 so as not to allow air bubbles to enter. The radio wave reflector 11 is thereby produced.

The radio wave reflector 11 produced as Example 2 had a configuration of “Configuration B” and did not have an adhesive layer 14 and a protective layer 15. The thickness L11 of the radio wave reflector 11 was 0.08 mm. The radio wave reflection intensity in a flat state was −23 dB, the Young's modulus was 0.5 GPa, the flexural modulus was 0.6 GPa, the surface resistivity was 1.4 Ω/□, and the change rate R in surface resistivity when curved was 2.8%. The total light transmittance of the radio wave reflector 11 was 0.1%. The thickness L8 of the substrate layer 13 was 0.08 mm. The arrangement pattern of the electric conductor 12 of the conductive thin film layer 16, the shape of the arrangement pattern, the line width L6, the thickness L3, the interval L7 between adjacent electric conductors 12, the material etc. of the electric conductor, and other configurations were the same as those of Example 1. The radio wave reflector 11 of Example 2 was produced in a manner similar to that of Example 1, except that the adhesive layer 14 and protective layer 15 were not provided.

The radio wave reflector 11 produced as Example 3 had a configuration of “Configuration A” in the same manner as in Example 1. The thickness L11 of the radio wave reflector 11 was 0.5 mm. The radio wave reflection intensity in a flat state was −25 dB, the Young's modulus was 0.08 GPa, the flexural modulus was 2.2 GPa, the surface resistivity was 1.5 Ω/□, and the change rate R in surface resistivity when curved was 9.8%. The total light transmittance of the radio wave reflector 11 was 87%. The thickness L8 of the substrate layer 13 was 0.19 mm. The adhesive layer 14 was rubber. The thickness L4 of the adhesive layer 14 was 0.12 mm, and the thickness L5 of the protective layer 15 was 0.19 mm. The arrangement pattern of the electric conductor 12 of the conductive thin film layer 16, the shape of the arrangement pattern, the line width L6, the thickness L3, the interval L7 between adjacent electric conductors 12, the material etc. of the electric conductor, and other configurations were the same as those of Example 1.

The radio wave reflector 11 produced as Example 4 had a configuration of “Configuration C” and did not have an adhesive layer 14 and a protective layer 15. The thickness L11 of the radio wave reflector 11 was 0.05 mm. The radio wave reflection intensity in a flat state was −26 dB, the Young's modulus was 70 GPa, the flexural modulus was 0.05 GPa, the surface resistivity was 3.8 Ω/□, and the change rate R in surface resistivity when curved was 3.9%. The total light transmittance of the radio wave reflector 11 was 90%. The thickness L8 of the substrate layer 13 was 0.05 mm. The arrangement pattern of the electric conductor 12 of the conductive thin film layer 16 was of the conjugation type, and the shape of the arrangement pattern was grid. The line width L6 and the thickness L3 of the electric conductor 12, the interval L7 between adjacent electric conductors 12, the material etc. of the electric conductor, and other configurations were the same as those of Example 1. The radio wave reflector 11 of Example 4 was produced in a manner similar to that of Example 1, except that the adhesive layer 14 and protective layer 15 were not provided.

The radio wave reflector 11 produced as Example 5 had a configuration of “Configuration D.” The thickness L11 of the radio wave reflector 11 was 0.5 mm. The radio wave reflection intensity in a flat state was −25 dB, the Young's modulus was 0.1 GPa, the flexural modulus was 3.7 GPa, the surface resistivity was 2.1 Ω/□, and the change rate R in surface resistivity when curved was 9.5%. The total light transmittance of the radio wave reflector 11 was 0.1%. The thickness L8 of the substrate layer 13 was 0.25 mm. The arrangement pattern of the electric conductor 12 of the conductive thin film layer 16 was of the conjugation type, and the shape of the arrangement pattern was grid. The adhesive layer 14 was rubber. The thickness L4 of the adhesive layer 14 was 0.06 mm, and the thickness L5 of the protective layer 15 was 0.19 mm. The line width L6 and the thickness L3 of the electric conductor 12, the interval L7 between adjacent electric conductors 12, the material etc. of the electric conductor, and other configurations were the same as those of Example 1.

The radio wave reflector 11 produced as Example 6 had a configuration of “Configuration A.” The radio wave reflection intensity in a flat state was −27 dB, the Young's modulus was 0.08 GPa, the flexural modulus was 2.2 GPa, the surface resistivity was 0.003 Q/□, and the change rate R in surface resistivity when curved was 1.18. The total light transmittance of the radio wave reflector 11 was 80%. The arrangement pattern of the electric conductor 12 of the conductive thin film layer 16 was of the isolation type, and the shape of the arrangement pattern was circular. The thickness L3 of the electric conductor 12 was 0.5 μm, the diameter L1 of the electric conductor 12 was 1000 μm, and the interval L2 between adjacent electric conductors 12 was 10 μm (tolerance ±10 μm; the same applies below). The conductive thin film layer 16 had a surface roughness Sa of 2.3 μm and a coverage of 23%. Other configurations were the same as those of Example 1.

A method for producing the radio wave reflectors 11 of Examples 6 and 7 and Comparative Example 3 are described below. First, an electric conductor 12 is formed on a substrate layer 13. In the production of Examples 6 and 7 and Comparative Example 3, a roll-to-roll sputtering apparatus was used. A target including a metal (for example, silver) is attached to a cathode provided in a film-forming chamber of the sputtering apparatus. A ground shield with a size such that 5% of the cathode is concealed is provided on the cathode. The film-forming chamber of the sputtering apparatus is evacuated by a vacuum pump to reduce the pressure to, for example, 3.0×10⁻⁴ Pa and, for example, argon gas is supplied at a predetermined flow rate (100 sccm). In this state, the substrate layer 13 is conveyed to a position under the cathode, for example, at a conveying speed of 0.1 m/min and a tension of 100 N. A pulsed power of 5 kW is supplied from a bipolar power supply connected to the cathode, whereby metal is ejected from the target and deposited on the surface of the substrate layer 13, thus forming a metal thin film. A mask is formed on the surface of the metal thin film according to the arrangement pattern of the electric conductor 12 by photolithography. Subsequently, unmasked portions of the metal thin film are removed using a chemical. The masked portions are then removed to form electric conductors 12. In this manner, a conductive thin film layer 16 with a plurality of the electric conductors 12 is formed on the substrate layer 13.

Whether or not the metal thin film is formed with a desired thickness is evaluated, for example, by the following procedure. Indentations that penetrate the metal thin film at predetermined locations (about 30 locations in this embodiment) are formed, for example, using a nanoindenter (TI950, produced by Hysitron, Inc.). Using a laser microscope (VK-X1000/1050, produced by Keyence Corporation), the thickness of the metal thin film is measured from the gap created by each indentation. The average film thickness and standard deviation are obtained from the measurement values obtained at about 30 locations. Whether or not the average film thickness is the desired thickness L3 (for example, 50 nm), and whether or not the variation in the measurement values is within the desired range (for example, the standard deviation is within 5) are evaluated.

A protective layer 15 is then attached to the electric conductor 12 by an adhesive layer 14. Using the adhesive layer 14, the protective layer 15 is attached onto the electric conductor 12 of the substrate layer 13 so as not to allow air bubbles to enter. The radio wave reflector 11 is thereby produced.

The radio wave reflector 11 produced as Example 7 had a configuration of “Configuration A.” The radio wave reflection intensity in a flat state was −29 dB, the Young's modulus was 0.08 GPa, the flexural modulus was 2.2 GPa, the surface resistivity was 9.8 Ω/□, and the change rate R in surface resistivity when curved was 1.2%. The total light transmittance of the radio wave reflector 11 was 79%. The arrangement pattern of the electric conductor L2 of the conductive thin film layer 16 was of the isolation type, and the shape of the arrangement pattern was circular. The thickness L3 of the electric conductor 12 was 0.04 μm, the diameter L1 of the electric conductor 12 was 1000 μm, and the interval L2 between adjacent electric conductors 12 was 10 μm. The electric conductor 12 was a metal thin film formed of titanium. The conductive thin film layer 16 had a surface roughness Sa of 3.1 μm and a coverage of 23%. Other configurations were the same as those of Example 1.

The radio wave reflector 11 produced as Example 8 had a configuration of “Configuration D.” The flexural modulus was 3.9 GPa, and the change rate R in surface resistivity when curved was 9.6%. Other configurations were the same as those of Example 5.

In the radio wave reflector 11 produced as Example 9, the adhesive layer 14 was acrylic. Other configurations were the same as those of Example 3.

The radio wave reflector produced as Comparative Example 1 was a single metal plate formed of aluminum with a thickness of 0.5 mm. The radio wave reflection intensity in a flat state was −24 dB, the Young's modulus was 70 GPa, the flexural modulus was 71 GPa, the surface resistivity was 0.00005 Ω/□, and the change rate R in surface resistivity when curved was 0.1%. The total light transmittance of the radio wave reflector 11 was 0%. The surface roughness Sa was 1.06 μm.

The radio wave reflector produced as Comparative Example 2 had a configuration of “Configuration B” and did not have an adhesive layer 14 and a protective layer 15. The thickness L11 of the radio wave reflector 11 was 0.6 mm. The radio wave reflection intensity in a flat state was −23 dB, the Young's modulus was 0.5 GPa, the flexural modulus was 0.6 GPa, and the surface resistivity was 1.4 Ω/□. The surface resistivity of the radio wave reflector in a curved state along a curved surface with a curvature radius of 200 mm could not be measured since the radio wave reflector 11 was damaged during curvature of the radio wave reflector 11, and the change rate R in surface resistivity was unmeasurable. The total light transmittance of the radio wave reflector 11 was %. The thickness L8 of the substrate layer 13 was 0.6 mm. The arrangement pattern of the electric conductor 12 of the conductive thin film layer 16, the shape of the arrangement pattern, the line width L6, the thickness L3, the interval L7 between adjacent electric conductors 12, the material etc. of the electric conductor, and other configurations were the same as those of Example 1. The radio wave reflector 11 of Comparative Example 2 was produced in a manner similar to that of Example 1, except that an adhesive layer 14 and protective layer 15 were not provided, and that the substrate layer 13 was set to a greater thickness than that of Example 2.

The radio wave reflector produced as Comparative Example 3 had a configuration of “Configuration A,” The radio wave reflection intensity in a flat state was −38 dB, the Young's modulus was 0.08 GPa, the flexural modulus was 2.2 GPa, the surface resistivity was 20.5 Ω/□, and the change rate R in surface resistivity was 0.6%. The total light transmittance of the radio wave reflector 11 was 80%. The arrangement pattern of the electric conductor 12 of the conductive thin film layer 16 was of the isolation type, and the shape of the arrangement pattern was circular. The thickness L3 of the electric conductor 12 was 0.02 μm, the diameter L1 of the electric conductor 12 was 1000 nm, and the interval L2 between adjacent electric conductors 12 was 10 μm. The electric conductor 12 was a metal thin film formed of titanium. The conductive thin film layer 16 had a surface roughness Sa of 2.6 μm and a coverage of 23%. Other configurations were the same as those of Example 1.

The radio wave reflector produced as Comparative Example 4 had a configuration of “Configuration D.” The radio wave reflection intensity in a flat state was −31 dB, the Young's modulus was 0.8 GPa, the flexural modulus was 4.2 GPa, and the change rate R in surface resistivity was 13%. The total light transmittance of the radio wave reflector 11 was 80%. Other configurations were the same as those of Example 5.

### Measurement of Reflection Intensity

The intensity of the reflective waves of Examples 1 to 9 and Comparative Examples 1 to 4 (also collectively referred to as “sample”), which are measurement targets, was measured by the following procedure according to the method for measuring the amount of reflection described in JIS R 1679:2007. The sample in a flat state was placed on a sample stand. A transmitting antenna and a receiving antenna were disposed according to the radio wave incident angle θ1 and the radio wave reflection angle θ2 (θ1, θ2=45°). The distance between the sample and the receiving antenna and the distance between the sample and the transmitting antenna were set to 1 m. Radio waves with continuously varying frequencies of 3 to 300 GHz were output from the transmitting antenna, and the amount of reflection (reflection intensity) of the radio waves was measured. The amount of reflection at a frequency of 28.5 GHz, and the frequency band in which the amount of reflection was −30 dB or more were determined.

First, a reference metal plate (aluminum A1050 plate, thickness: 3 mm) was placed on a sample stand. The reception level was measured and recorded using a scalar network analyzer. In this measurement, coaxial cables of the receiving antenna and the transmitting antenna were directly connected by a scalar network analyzer, and the signal level at each frequency was calibrated to 0. The device was then reconfigured and the measurement was performed. After the reference metal plate was removed from the sample stand, each sample was placed on the sample stand and the reception level was measured and recorded. The amount of reflection in the specular reflection direction of the radio wave reflector 11 to be measured was obtained by subtracting the reception level of the reference metal plate from the measured reception level. Each sample was measured in the same manner. When the frequency of radio waves was 10 GHz or less, the sample was appropriately irradiated with a plane wave using a millimeter wave lens in consideration of the first Fresnel radius of the rectangular horn antenna used.

### Measurement of Surface Resistivity and Calculation of Change Rate R of Surface Resistivity

The surface resistivity R1 of the radio wave reflector 11 in a flat state was measured in accordance with the four-terminal method specified in JIS K 7194:1994 by bringing measurement terminals into contact with the surface of the conductive thin film layer 16 formed of the electric conductor 12. If the conductive thin film layer 16 was protected with a resin sheet etc. and was not exposed, the measurement was performed by an eddy current method using a non-contact resistance measurement instrument (product name: EC-80P or an equivalent thereof, produced by Napson Corporation). The surface resistivity of the conductive thin film layer 16 is shown as the surface resistivity of the radio wave reflector 11.

The surface resistivity R2 of the radio wave reflector 11 in a curved state along a curved surface with a curvature radius of 200 mm was measured as follows. A column member having a circular or semicircular cross-section with a radius of 200 mm was prepared, and the sample was curved along the outer peripheral surface of the column member and fixed. The surface resistivity R2 was then measured according to the four-terminal method mentioned above. The change rate R in surface resistivity when curved was determined by the following formula.

R(%)=(R2−R1)/R1×100.

When the arrangement pattern of the electric conductor 12 of the conductive thin film layer 16 was of the conjugation type as in Examples 1 to 5 and Comparative Example 2, or when a single metal plate was used as in Comparative Example 1, the measurement target was set to the entire conductive thin film layer 16, that is, any twenty points on the plurality of electric conductors 12 constituting the conductive thin film layer 16. The arithmetic mean values of the obtained measurement values were defined as surface resistivities R1 and R2, When the arrangement pattern of the electric conductor 12 was of the isolation type as in Examples 6 and 7 and Comparative Example 3, the measurement target was set to any twenty points on the electric conductors 12 from among the plurality of the electric conductors 12, and the arithmetic mean values of the obtained measurement values were defined as surface resistivities R1 and R2. In Examples 6 and 7and Comparative Example 3, the electric conductors 12 in plan view each had a circular shape with a diameter of 1000 nm, and the measurement target for surface resistivities R1 and R2 was set to each electric conductor 12. However, when the area of each electric conductor 12 in plan view was approximately a few square centimeters, the measurement target for surface resistivities R1 and R2 was set to the entire conductive thin film layer 16 for the measurement.

### Measurement of Flexural Modulus and Young's Modulus

The flexural modulus was measured in accordance with the method described in JIS K 7171, and the Young's modulus was measured in accordance with the method described in JIS K 7127-1999.

### Evaluation Indices

Two evaluation indices for reflection direction-correcting properties and unevenness followability were set. The reflection direction-correcting properties are used to evaluate whether or not the radio wave reflector 11 can reflect a radio wave in a desired direction with a practical reflection intensity by bending the radio wave reflector 11 for installation in order to reflect a radio wave in a direction that is rotated by a specific angle with respect to the specular reflection direction, with the reflection point being set as the center,

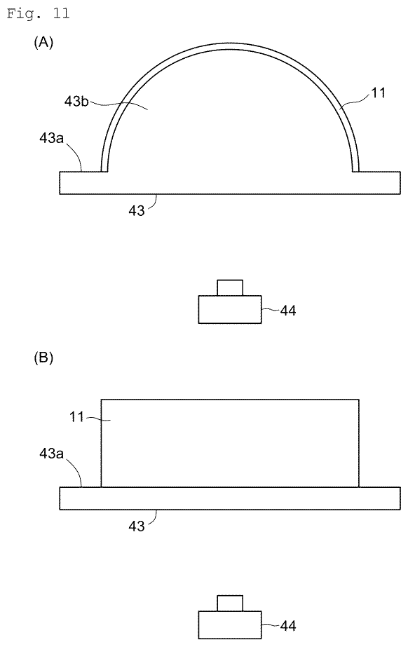

The reflection direction-correcting properties are evaluated as follows. As shown in FIG. 10, the radio wave reflector 11 is placed on an installation surface 42, which has a flat surface and is parallel to the horizontal direction. The radio wave reflector 11 is then bent along a line passing through the center point (center line) of the opposite side of the square shape. The bending angle θ3 between the installation surface 42 and the reflective surface of the radio wave reflector 11 is set to 10 degrees. A transmitting antenna 40 is installed so that the incident angle θ1 of an incident wave is 60 degrees when the reflection point 11a is on the center line of the radio wave reflector 11. The distance between the reflection point 11a and the transmitting antenna 40 is set to 5 m. A receiving antenna 41, which is a receiver 21, is located at a position rotated clockwise in FIG. 10 by a rotation angle θ4, which is set to 50 degrees, from a normal line 22, which is set to 0 degrees. That is, the position of the receiving antenna 41 is closer to the normal line 22 by a rotation angle of 10 degrees, with the reflection point 11a being set as the center, from the specular reflection direction (arrow A3) in the case when the radio wave reflector 11 is installed in a flat state on the installation surface 42. The distance between the reflection point 11a and the receiving antenna 41 are set to 5 m.

A radio wave having a frequency of 28 GHz was output from the transmitting antenna 40, and the amount of reflection (reflection intensity) in the receiving antenna 41 was measured. The measurement method for reflection intensity is the same as that described above. The reflection direction-correcting properties were evaluated as “A” when the intensity of a radio wave received by the receiving antenna 41 was −30 dB or more, and as “B” when the intensity was less than −30 dB.

The unevenness followability is evaluated as follows. As shown in FIG. 11, a test stand 43 having a convex portion 43b projecting upward from the upper surface of a plate-shaped portion 43a is prepared. The convex portion 43b is a semi-circular column having a semi-circular cross-section with a radius of 200 mm (a curved surface with a curvature radius of 200 mm). The test stand 43 is transparent as a whole and has a total light transmittance of 75% at a portion having the longest length in the up-down direction in the side view of the test stand 43 shown in FIG. 11. An image capturing apparatus 44, such as a camera, is disposed below the test stand 33.

The radio wave reflector 11 is attached to the surface of the convex portion 43b of the test stand 43 with an adhesive (PPX, produced by Cemedine Co., Ltd.) so that the substrate layer 13 is in contact with the surface of the convex portion 43b. The electric conductor 12 is then photographed through the test stand 43 with the image capturing apparatus 44. The obtained images are analyzed by computer using image processing software (Avizo, produced by Thermo Fisher Scientific). In the analysis, the area of the overlap between the radio wave reflector 11 and the convex portion 43b of the test stand 43 (i.e., the area of the radio wave reflector 11) and the area of air bubbles present between the surface of the convex portion 43b of the test stand 43 and the radio wave reflector 11 are determined. Then, by excluding the area of the air bubbles from the area of the radio wave reflector 11, the area in which the radio wave reflector 11 is in intimate contact with the convex portion 43b with the adhesive is calculated. The unevenness followability is evaluated as “A” when the percentage of the area of the radio wave reflector 11 that is in intimate contact with the convex portion 43b is 90% or more relative to the area of the radio wave reflector 11, and is evaluated as “B” when the percentage is less than 90%. The expression “intimate contact” indicates that no air bubbles are present between the surface of the convex portion 43b and the radio wave reflector 11 although an adhesive is present.

### Evaluation Results

Table 1 shows the evaluation results. In all of Examples 1 to 9, the specular reflection intensity of the radio wave reflector 11 in a flat state was −30 dB or more. The reflection direction-correcting properties were evaluated as “A,” and the unevenness followability was evaluated as “A.” In contrast, in Comparative Example 1, which was formed of an aluminum plate, the specular reflection intensity was more than −30 dB, and the reflection direction-correcting properties were evaluated as “A”; however, the plate could not be curved, and the unevenness followability was evaluated as “B.” In Comparative Example 2, in which the thickness of the substrate layer 13 was set to be greater than that of Example 2, although the specular reflection intensity was more than −30 dB, the reflection direction-correcting properties were evaluated as “B.” Since Comparative Example 2 could not be curved, the unevenness followability was evaluated as “B.” In Comparative Example 3, in which the thickness L3 of the electric conductor 12 was set to be smaller than that of Example 7, sufficient specular reflection intensity could not be achieved, and the reflection direction-correcting properties were evaluated as “B.” Comparative Example 4 had a higher flexural modulus than that of Example 5; Comparative Example 4 could not be curved, and the unevenness followability was evaluated as “B.”

TABLE 1

| | | Ex. 1 | Ex. 2 | Ex. 3 | Ex. 4 | Ex. 5 | Ex. 6 | Ex. 7 |
|---|---|---|---|---|---|---|---|---|
| Radio wave | Configuration of radio wave reflector | Config- | Config- | Config- | Config- | Config- | Config- | Config- |
| reflector | | uration A | uration B | uration A | uration C | uration D | uration A | uration A |
| | Thickness of radio wave reflector (mm) | 0.4 | 0.08 | 0.5 | 0.05 | 0.5 | 0.3 | 0.3 |
| | Specular reflection intensity (dB) | −24 | −23 | −25 | −26 | −25 | −27 | −29 |
| | at 28.5 GHz in a flat state | | | | | | | |
| | Frequency band (GHz) satisfying | 3-300 | 3-300 | 3-300 | 3-300 | 3-300 | 20-60 | 20-60 |
| | reflection intensity of −30 dB or more | | | | | | | |
| | Young's modulus (GPa) | 0.08 | 0.5 | 0.08 | 70 | 0.1 | 0.08 | 0.08 |
| | Flexural modulus (GPa) | 2.2 | 0.6 | 2.2 | 0.05 | 3.7 | 2.2 | 2.2 |
| | Surface resistivity (Ω/□) | 1.7 | 1.4 | 1.5 | 3.8 | 2.1 | 0.003 | 9.8 |
| | Change rate in surface resistivity (%) | 4.3 | 2.8 | 9.8 | 3.9 | 9.5 | 1.1 | 1.2 |
| Substrate layer | Thickness of substrate layer (mm) | 0.13 | 0.08 | 0.19 | 0.05 | 0.25 | 0.13 | 0.13 |
| Conductive | Arrangement pattern of electric conductor | Conju- | Conju- | Conju- | Conju- | Conju- | Isolation | Isolation |
| thin film layer | | gation | gation | gation | gation | gation | type | type |
| | | type | type | type | type | type | | |
| | Shape of arrangement pattern | Staggered | Staggered | Staggered | Grid | Gid | Circular | Circular |
| | Line width of electric conductor (nm) | 400 | 400 | 400 | 400 | 400 | — | — |
| | Thickness of electric conductor (μm) | 0.4 | 0.4 | 0.4 | 0.4 | 0.4 | 0.5 | 0.04 |
| | Diameter (μm) | — | — | — | — | — | 1000 | 1000 |
| | Interval (μm) between | 100 | 100 | 100 | 100 | 100 | 10 | 10 |
| | adjacent electric conductors | | | | | | | |
| | Material of electric conductor | Silver | Silver | Silver | Silver | Silver | Silver | Titanium |
| Adhesive layer | Thickness of adhesive layer (mm) | 0.04 | — | 0.12 | — | 0.06 | 0.04 | 0.04 |
| | Type of adhesive | Rubber | — | Rubber | — | Rubber | Rubber | Rubber |
| Protective layer | Thickness of protective layer (mm) | 0.13 | — | 0.19 | — | 0.19 | 0.13 | 0.13 |
| Evaluation | Reflection direction-correcting properties | A | A | A | A | A | A | A |
| | Unevenness followability | A | A | A | A | A | A | A |

| | | | | Comp. | Comp | Comp. | Comp. |
|---|---|---|---|---|---|---|---|
| | | Ex. 8 | Ex. 9 | Ex. 1 | Ex. 2 | Ex. 3 | Ex. 4 |
| Radio wave | Configuration of radio wave reflector | Config- | Config- | Metal | Config- | Config- | Config- |
| reflector | | uration D | uration A | plate | uration B | uration A | uration D |
| | Thickness of radio wave reflector (mm) | 0.5 | 0.5 | 0.5 | 0.6 | 0.3 | 0.5 |
| | Specular reflection intensity (dB) | −25 | −25 | −24 | −23 | −38 | −31 |
| | at 28.5 GHz in a flat state | | | | | | |
| | Frequency band (GHz) satisfying | 3-300 | 3-300 | 3-300 | 3-300 | — | 3-300 |
| | reflection intensity of −30 dB or more | | | | | | |
| | Young's modulus (GPa) | 0.1 | 0.08 | 70 | 0.5 | 0.08 | 0.8 |
| | Flexural modulus (GPa) | 3.9 | 2.2 | 71 | 0.6 | 2.2 | 42 |
| | Surface resistivity (Ω/□) | 2.1 | 1.5 | 0.00005 | 1.4 | 20.5 | 2.1 |
| | Change rate in surface resistivity (%) | 9.6 | 9.8 | 0.1 | Unmeasurable | 0.6 | 1.3 |
| Substrate layer | Thickness of substrate layer (mm) | 0.25 | 0.19 | — | 0.6 | 0.13 | 0.25 |
| Conductive | Arrangement pattern of electric conductor | Conju- | Conju- | — | Conju- | isolation | Conju- |
| thin film layer | | gation | gation | | gation | type | gation |
| | | type | type | | type | | type |
| | Shape of arrangement pattern | Gid | Staggered | — | Staggered | Circular | Grid |
| | Line width of electric conductor (nm) | 400 | 400 | — | 400 | — | 400 |
| | Thickness of electric conductor (μm) | 0.4 | 0.4 | — | 0.4 | 0.02 | 0.4 |
| | Diameter (μm) | — | — | — | — | 1000 | — |
| | Interval (μm) between | 100 | 100 | — | 100 | 10 | 100 |
| | adjacent electric conductors | | | | | | |
| | Material of electric conductor | Silver | Silver | — | Silver | Titanium | Silver |
| Adhesive layer | Thickness of adhesive layer (mm) | 0.06 | 0.12 | — | — | 0.04 | 0.06 |
| | Type of adhesive | Rubber | Acrylic | — | — | Rubber | Rubber |
| Protective layer | Thickness of protective layer (mm) | 0.19 | 0.19 | — | — | 0.13 | 0.19 |
| Evaluation | Reflection direction-correcting properties | A | A | A | B | B | A |
| | Unevenness followability | A | A | B | B | A | B |

Embodiments of the present invention have been described above. However, the present invention is not limited to the above-described embodiments. Various modifications are possible without departing from the gist of the present invention. The dimensions, materials, shapes, relative positions, and the like of components described as embodiments or shown in the drawings are not intended to limit the scope of the present invention, but are merely illustrative examples. In the present specification, “parallel” means not only cases where two straight lines, sides, surfaces, etc. do not intersect with each other even if they are extended, but also cases where two straight lines, sides, surfaces, etc. intersect with each other at an angle of 10° or less.

### DESCRIPTION OF REFERENCE NUMERALS

11: radio wave reflector
11a: reflection point
12, 12A, 12B: electric conductor
13, 13A, 13B: substrate layer
14, 14A, 14B; adhesive layer
15: protective layer
16: conductive thin film layer
20: radio wave source
21: receiver
30, 30A, 30B, 30C: building material
L1: diameter of electric conductor
L2: interval between adjacent electric conductors
L3: thickness of electric conductor
L4: thickness of adhesive layer
L5: thickness of protective layer
L6: line width of electric conductor
L7: interval between adjacent electric conductors
L8: thickness of substrate layer
L10 one-side length of radio wave reflector
L11: thickness of radio wave reflector
R: change rate in surface resistivity when curved
R1, R2: surface resistivity

1. A radio wave reflector for reflecting radio waves, wherein
when the radio wave reflector is in a flat state and is caused to reflect a radio wave at an incident angle of an incident wave of 15 degrees or more and 75 degrees or less, the intensity of a reflective wave as specular reflection of the incident wave is −30 dB or more relative to the intensity of the incident wave at a frequency,
the change rate of the surface resistivity of the radio wave reflector curved along a curved surface with a curvature radius of 200 mm with respect to the surface resistivity of the radio wave reflector in a flat state is −10% or more and 10% or less, and
the radio wave reflector has a flexural modulus of 0.05 GPa or more and 4 GPa or less.

2. The radio wave reflector according to claim 1, wherein the incident wave has any frequency of 2 GHz or more and 300 GHz or less.

3. The radio wave reflector according to claim 1, which has a Young's modulus of 0.01 GPa or more and 80 GPa or less.

4. The radio wave reflector according to claim 1, which has a thickness of 0.01 mm or more and 0.5 mm or less.

5. The radio wave reflector according to claim 1, which comprises at least a conductive thin film layer comprising an electric conductor for reflecting radio waves, and a substrate layer comprising a substrate and laminated to the conductive thin film layer.

6. The radio wave reflector according to claim 5, wherein
the radio wave reflector comprises the conductive thin film layer, the substrate layer, a protective layer comprising a protective material for protecting the conductive thin film layer, and an adhesive layer comprising an adhesive for bonding the conductive thin film layer and the layer comprising the protective material, and
the substrate layer, the conductive thin film layer, the adhesive layer, and the protective layer are laminated in this order.

7. The radio wave reflector according to claim 1, wherein the surface resistivity of the radio wave reflector in a flat state is 0.003 Ω/□ or more and 10 Ω/□ or less.

8. The radio wave reflector according to claim 6, wherein the protective layer is subjected to anti-glare treatment or anti-reflection treatment.

9. A building material comprising the radio wave reflector of claim 1.
